(19) United States
(12) Patent Application Publication
(10) Pub. No.: US 2025/0339826 A1
(43) Pub. Date: Nov. 6, 2025

(54) DEVICE FOR PIVOTING ALONG A TRAJECTORY CURVE

(71) Applicant: HS-TUMBLER GMBH, Quakenbrück (DE)

(72) Inventor: Bernhard Hukelmann, Quakenbrück (DE)

(21) Appl. No.: 18/869,753

(22) PCT Filed: May 26, 2023
(86) PCT No.: PCT/EP2023/064286

§ 371 Date: Nov. 26, 2024

(30) Foreign Application Priority Data
May 27, 2022 (DE) 102022205325.7

(51) Int. Cl. B01F 31/20; B01F 35/30

(52) U.S. Cl. CPC B01F 31/201; B01F 2035/352

(57) ABSTRACT

The invention relates to a device which can be used as a drive, with which a container holder and a container fixed thereto can be driven and forcibly guided along a trajectory curve, and to a method for treating ingredients, in particular mixtures, in a container which is driven and forcibly guided along a trajectory curve by means of the device. The device has a pivot arm articulated to a first stationary pivot bearing, the pivot bearing being set up for pivoting along two axes which are arranged perpendicularly to the longitudinal axis of the first pivot arm, a container receptacle attached to the end of the pivot arm opposite the pivot bearing, and a container holder mounted on the end of the pivot arm opposite the pivot bearing, a first lever driven for reciprocating movement, which is articulated to the pivot arm at a spacing from the pivot bearing, and a second lever driven for reciprocating movement, which is articulated to the first pivot arm at a spacing from the pivot joint, wherein the first lever and the second lever are arranged to move the first pivot arm about the two axes of the first pivot bearing.

The present invention relates to a device which can be used as a drive, by which a container holder and a container fixed thereto can be driven and positively guided along a trajectory curve, and to a method for treating ingredients, in particular mixtures, in a container which is driven and positively guided along a trajectory curve by means of the device.

The device has the advantage of being able to move a container in a positively driven reciprocating movement along a trajectory curve without featuring a linear guide and without featuring a link guide, in particular without featuring a linear drive, preferably exclusively with rotary drives and rotary bearings. The device is set up to use two motors or just one motor with an interposed transmission to generate a reciprocating movement of a container holder and a container attached to it in three dimensions, so that a container moved by the device moves its contents in three spatial directions.

The object of the invention is to provide an alternative device for a drive which enables a reciprocating movement along a trajectory curve which extends over three dimensions, wherein the drive shall not have a linear drive. Preferably, the drive shall have two motors or one motor with an intermediate transmission.

The invention achieves the object by the features of the claims and in particular by means of a device which has or consists of
a first pivot arm articulated at its first end to a first stationary first pivot bearing, wherein the first pivot bearing is arranged for pivoting along two axes which are arranged perpendicular to the longitudinal axis of the first pivot arm,
a container holder attached to the second end of the first pivot arm opposite the first end,
a first lever driven for a reciprocating movement, which first lever is articulated on the first pivot arm at a spacing from the first end of the first pivot arm,
and a second lever driven for a reciprocating movement, which second lever is articulated to the first pivot arm at a spacing from the first end of the first pivot arm, wherein the first lever and the second lever are arranged to move the first pivot arm about the two axes of the first pivot bearing.

The device has a pivot arm articulated to a first stationary pivot bearing, the pivot bearing being set up for pivoting along two axes which are arranged perpendicular to the longitudinal axis of the first pivot arm, a container holder attached to the end of the pivot arm opposite the pivot bearing, a first lever driven for reciprocating movement, which is articulated on the pivot arm at a spacing from the pivot bearing, and a second lever driven for reciprocating movement, which is articulated on the first pivot arm at a spacing from the pivot joint, wherein the first lever and the second lever are arranged to move the first pivot arm about the two axes of the first pivot bearing.

Preferably, the first lever and/or the second lever are driven at their second ends, opposite their first ends which are articulated to the first pivoting arm, by an eccentric drive for reciprocating movement. Therein, each lever can be driven by a separate eccentric drive, each of which has a motor, or both levers can be driven by a common eccentric drive which, for example, has or consists of a transmission driven by a common motor.

The first lever and the second lever are articulated independently of each other at different spacing from the first pivot bearing on the first pivot arm, or at the same spacing from the first pivot bearing. Optionally, the first lever and/or the second lever are articulated independently of one another to the second end of the first pivot arm or to the container holder.

Preferably, the first lever and the second lever are arranged to move the first pivot arm about the two axes of the first pivot bearing in that the first lever and the second lever are arranged at an angle of less than 180°, preferably 60-120°, more preferably 90±10°, in each case different or at the same angle, to the longitudinal axis of the first pivot arm. Further preferably, the first lever and the second lever are arranged approximately perpendicular to the longitudinal axis of the first pivot arm, in particular in a position of the first pivot arm in a central pivot position in the first pivot bearing. The first pivot arm in a central pivot position can be arranged vertically or at any angle to the horizon, wherein further optionally its first end can be arranged below or above or in the same plane as the first pivot bearing. Generally preferably, the first lever and the second lever are arranged at an angle of 60 to 120°, more preferably of 90±10° to each other, in particular with respect to their respective central pivot position.

Preferably, the first lever and the second lever are arranged to move the first pivot arm about the two axes of the first pivot bearing by being articulated to the container holder. In embodiments in which the first lever and the second lever are articulated to the container holder, they limit the movement of the container holder about an optional bearing by which the container holder is articulated to the second end of the first pivot arm. An optional bearing by which the container holder is articulated to the second end of the first pivot arm can be a universal joint, cardan bearing or ball joint. Alternatively, the container holder can be rigidly connected to the second end of the first pivot arm. In general, the first and second levers can be pivotably articulated at at least one, preferably both, of their ends by means of a barrel bearing.

The first lever is preferably pivotably articulated at its first end to the first pivot arm or to the container holder, e.g. in a pivot bearing which permits pivoting about its axis of rotation. The second lever, independently of or like the first lever, is pivotably articulated at its first end to the first pivot arm or to the container holder, e.g. in a pivot bearing that permits pivoting about its axis of rotation.

The first ends of the first and second levers can be spaced apart or articulated to the container holder or to the first pivot arm rotatably about a common axis of rotation.

The first pivot bearing can be arranged so that its two pivot axes are spaced apart or intersect. The first pivot bearing can have or consist of two spaced pivot bearings, e.g. ball bearings, each with their axes of rotation arranged perpendicular to each other and perpendicular to the longitudinal axis of the first pivot arm. Alternatively, the first pivot bearing can be a universal joint, in particular with intersecting axes of rotation, or can be a cardanic bearing whose axes of rotation intersect, or a ball joint which has, for example, a proportional ball which is mounted in a spherical shell.

Optionally, the first pivot bearing can be one whose pivot axes intersect and are arranged perpendicular to each other and perpendicular to the longitudinal axis of the pivot arm, e.g. a universal joint. Optionally, the pivot arm can be articulated at its first end to a pivot bearing and divided into two sections by a pivot bearing spaced from its first end. Each of these pivot bearings can be a ball joint or a universal joint. In this embodiment, it is preferred that one of the levers is hinged to the section of the pivot arm between its first end and the pivot bearing spaced therefrom, and the other of the levers is articulated to the section between the pivot bearing spaced from the first end and the second end. In embodiments with a second pivot arm, this can extend rigidly between its first end articulated in a third pivot bearing and its second end articulated on the container holder or also have two spaced pivot bearings, one at its first end and one spaced therefrom, the pivot axes of which are preferably parallel to those of the pivot bearings of the first pivot arm, further preferably at the same spacing from one another.

The first pivot arm can be mounted at its first end by means of a first pivot bearing and the container holder arranged at the second end of the first pivot arm can be articulated by means of a second pivot bearing. Therein, each pivot bearing can be a ball joint or a universal joint. In general, the container holder can be firmly connected to a section of the first pivot arm which is articulated to the second pivot bearing opposite the first pivot bearing, wherein the first ends of the first and second levers are pivotably articulated to an area which is part of the container holder and/or is firmly connected to the container holder, in particular to the section of the first pivot arm which is articulated to the second pivot bearing opposite the first pivot bearing. Accordingly, the first ends of the first and second levers can be articulated to the container holder in that they are articulated to a section of the first pivot arm that is rigidly connected to the container holder, this section being articulated to the second pivot bearing opposite the first pivot bearing.

Optionally, the container holder is rigidly connected to the second end of the first pivot arm. Preferably, the container holder is pivotably articulated to the second end of the first pivot arm, in particular about one or two axes, each arranged perpendicular to the longitudinal axis of the first pivot arm. A container holder arranged pivotably at the second end of the first pivot arm can be connected to the second end by means of a second pivot bearing which is pivotable about one axis, or the second pivot bearing is one which is pivotable about two spaced-apart or intersecting axes perpendicular to one another, for example as described with reference to the first pivot bearing, in particular a universal joint, a cardanic joint or a ball joint.

With the drive of the first lever and the second lever for reciprocating movement, the device is set up for reciprocating movement of the container holder along a trajectory curve in all three spatial directions in that the first pivot arm, through its articulation in the first pivot bearing, executes a movement of its second end and of the container holder arranged thereon via an apex point, which leads, for example, to a reciprocating movement along the longitudinal axis of the first pivot arm. Optionally, the device has only one pivot arm, also referred to as the first pivot arm.

Preferably, the device has a second pivot arm that is arranged parallel to the first pivot arm, in particular between a frame and the container holder. The second pivot arm is articulated at its first end in a third pivot bearing and is connected to the container holder at its opposite second end. Preferably, the first and third pivot bearings have the same structure. Optionally, the first and the third pivot bearings have a common first axis of rotation, e.g. a carrier mounted rotatably about its longitudinal axis, with first ends of the first and second pivot arms pivotably connected to this carrier at a spacing from each other about a second axis of rotation perpendicular to the longitudinal axis of the carrier. Therein, a container holder can be pivotably articulated to the two second ends of the first and second pivot arms only about axes, which are parallel to the second axis of rotation about which the first ends of the first and second pivot arms are pivotably articulated to a carrier.

The first and second eccentric drives can be mounted in a fixed position on a frame to which the first pivot bearing with the first pivot arm, optionally a third pivot bearing with a second pivot arm, is also attached.

Preferably, the second pivot arm between its first and second ends has the same length as the first pivot arm.

Optionally, the first and second eccentric drives are driven by a common motor, preferably with a transmission, which is further preferably shiftable in order to drive the eccentric drives with a constant or variable speed ratio to one another. The transmission is preferably a belt transmission or friction transmission.

The first and second eccentric drives can each be driven by a motor, one or both of which are controlled in order to drive the eccentric drives with a constant or variable speed ratio to one another. Alternatively, the first eccentric drive and the second eccentric drive can be driven by a common controlled and stationary arranged rotary motor with a transmission, wherein the transmission is preferably set up to change the transmission ratio and/or the phase offset for the two eccentric drives relative to each other. Each controlled motor can be formed by a motor with a controller; preferably, in embodiments with two motors, both motors are controlled by a common controller.

The device according to the invention has the advantage that it is driven by two rotary motors with eccentric drive or one rotary motor with a transmission and eccentric and has, for example, no linear drive and no linear guides or sliding block guides.

The device is set up for the reciprocating movement of the container holder and a container attached thereto along a trajectory curve, e.g. with a rotational frequency of one or both eccentric drives, equal or different, of at least 1 Hz, in order to drive the reciprocating movement of the container holder. The trajectory curve of the reciprocating movement of the container holder is generated by superimposing the movement along two axes, each with a different frequency and/or with a phase offset of the rotational frequency of the eccentric drives, e.g. over a path of the container holder along each of two axes of preferably at least 2.5 mm, at least 1 cm, at least 2 cm or at least 3 cm or at least 10 cm, e.g. up to 50 cm, up to 30 cm, up to 20 cm or, in the case of shorter paths, up to 10 cm. Therein, the path of the container holder along each axis can be the same as the path of the reciprocating movement of the levers.

The reciprocating movement of the container holder can, for example, extend over a path of at least 1.5 mm, preferably at least 3 mm, preferably at least 1 cm, preferably at least 2 cm or at least 5 cm, at least 10 cm or at least 15 cm, e.g. up to 50 cm, up to 30 cm or up to 20 cm. Further preferably, the eccentric drives for moving the container reciprocating are controlled harmoniously along a trajectory curve. The reciprocating movement of the container holder is non-linear and can be sinusoidal, loop-shaped or arc-shaped, preferably running along a trajectory curve, which is preferably in the plane or two-dimensional. This is because, in general, a non-linear axis of movement, preferably a reciprocating movement along a trajectory curve, which may be a Lissajous figure or hypocycloid, promotes uniform and intensive mixing of components of a composition contained in a container attached to the container holder, even for components of the composition having a similar or equal specific gravity. Each axis of movement in itself can be linear or arcuate, so that the non-linear movement of the container holder and a container attached thereto is generated from the superposition of the movements along two axes of movement.

The container holder is driven for reciprocating movement along at least one trajectory curve which can be generated by superimposing the reciprocating movements along at least two axes which lie at an angle to one another, preferably two of the axes lying in the plane of the cross-section of the container to be attached to the container holder, the reciprocating movement along each axis taking place at different frequencies and/or with a phase offset. The trajectory curve can be generated by superimposing the reciprocating movement along two or three axes at different frequencies and/or with phase offset and has a sequence of curve segments, at least one of which, preferably each, comprises or consists of exactly one complete reciprocating movement along the axis along which the reciprocating movement takes place at the lower frequency, the superimposed reciprocating movements comprising the higher frequency or the same frequency, in each case optionally with phase offset, along the other axis or axes. Therein, the lower frequency of the complete reciprocating movement forms the frequency of the sequence of curve segments. At least one of the eccentric drives, preferably both, is controlled to rotate at the frequency. For each curve segment, a frequency ratio of the reciprocating movement along two axes of at maximum 1:20 or at maximum 1:15 or at maximum 1:10, at maximum 1:4 or at maximum 1:3 is preferred, more preferably between 1:1 and 1:2, even more preferably greater than 1:1 to 1:2 or up to 1:1.5, e.g. with a frequency ratio of 1:1.001 to 1:2 or up to 1:1.5.

In the case of a trajectory curve that can be generated by superimposing the reciprocating movement along two axes at different frequencies and/or with phase offset of the rotation of the eccentric drives, the axes preferably lie in the plane of the cross-section of the container that is to be attached to the container holder. In general, the linear or curved axes of movement are preferably at right angles to each other. In general, the trajectory curve does not include any rotation of the container holder or of the container about its own axis.

In general, the device is set up to drive the container holder for the container along a trajectory curve which is formed by superimposing the reciprocating movement along at least two superimposed linear or arcuate axes of movement which are at an angle to one another, the reciprocating movement along the axes taking place at different frequencies and/or with a phase offset. The axes of movement along which the superimposed reciprocating movements take place at different frequencies and/or with phase offset form the trajectory curve along which the reciprocating movement of the container holder and of the container attached thereto takes place.

By moving the container holder along the trajectory curve, the device is set up to accelerate components in the container relative to the container, so that solids and/or liquids contained in the container as components are sheared by the acceleration against the container wall and by the movement along or against the container wall and are thus intensively mixed.

Since the trajectory curve can be adjusted or predetermined by the different frequencies and/or the phase offset of the superimposed movements along the axes, the device is set up for the reciprocating movement of the container holder and the container attached to it along the trajectory curve and for the relative movement of components or their mixture with respect to the container.

Generally preferably, the container holder and a container to be attached thereto are not driven in rotation and are further preferably not or not fully rotatable, e.g. articulated to rotate by a maximum of 30° or by a maximum of 20° or 10° about its centre axis or not rotatable, e.g. in a device having a first and a second pivot arm. It is generally preferred that the container holder or the container is driven exclusively for a reciprocating movement along a trajectory curve.

The trajectory curve, which can be adjusted or predetermined by the different frequencies and/or the phase offset of the superimposed movements of the container holder along at least two axes of movement, accelerates solids and/or liquids as components and a mixture of these relative to the container, which is attached to the container holder. The reciprocating movement of the container drives the components in the container and the mixture thereof to move against the inner wall of the container.

The trajectory curve can be used to determine the angle of incidence and the angle of emergence of the solids and/or liquids and the mixture of these against the container wall. In addition, the device is optionally set up to move the container holder and the container on it along the trajectory curve with adjustable or predetermined acceleration and speed. In that the device is arranged for an adjustable or predetermined trajectory curve and/or an adjustable or predetermined acceleration and/or an adjustable or predetermined speed along the trajectory curve of the reciprocating movement, solids and/or liquids and the mixture thereof are driven with adjustable or predetermined acceleration and/or speed relative to the container and allows a predetermined or continuous adaptation of the process to the solids and/or liquids and to the mixture thereof.

In general, a trajectory curve can be formed by at least two superimposed individual oscillations; preferably, a trajectory curve resembles the trajectory curve that can be generated by superimposing reciprocating movements along at least two linear or arcuate axes of movement at different frequencies and/or by phase offset. A reciprocating movement along a trajectory curve that is similar to the reciprocating movement along linear or arcuate axes of movement that are superimposed on each other have different frequencies and/or a phase offset to each other. In general, a trajectory curve is therefore not a circular path.

The difference in frequencies can, for example, be at least 0.01 Hz and/or 0.01% to 900%. The phase offset of the reciprocating movements along the linear axes can be, for example, from 0.01° to 180°, preferably 1 to 179° of 360°, which corresponds to a complete reciprocating movement. Therein, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

Therein, the linear or arcuate axes of movement are, for example, perpendicular or at a different angle, e.g. 5° to 85° to each other, in particular in the plane of the cross-section of the container and/or perpendicular to a centre axis of a container attached to the container holder. Optionally, the trajectory curve contains at least one straight-line section, the end of which is, for example, an apex of the trajectory curve, at which the solids and/or liquids and the mixture thereof are accelerated away from the container wall or against the container wall.

In order to set different frequencies and/or a phase offset of the superimposed reciprocating movements along at least two movement axes, these reciprocating movements can be coupled together by a transmission or a link guide and driven by a motor. A transmission driven by a motor, which adjusts the reciprocating movement along the trajectory curve, can have a fixed transmission ratio between the superimposed movements along each axis, or an adjustable transmission ratio, e.g. a continuously or incrementally shiftable transmission. Optionally, the transmission can be slip-controlled, e.g. have a belt drive or be a friction transmission.

The output rotational speed of the transmission, which drives one or both of the eccentric drives, is preferably at least 1 Hz, more preferably at least 2.5 Hz, more preferably at least 5 Hz, more preferably at least 7 Hz, e.g. up to 50 Hz, up to 40 Hz, up to 30 Hz, up to 20 Hz or up to 10 Hz. Therein, the output rotational speed of the transmission is equal to the frequency of the reciprocating movement.

Alternatively, the reciprocating movement along each of the axes of movement may be driven by a separate motor, wherein for the purposes of the invention the lower output rotational speed is the frequency of the reciprocating movement and forms the frequency of the sequence of curve segments. In each embodiment, the speed of each drive motor may be controlled, fixed or variable over the duration of the process.

Therein, the device allows the trajectory curve to accelerate the solids and/or liquids as components and the mixture of these in a defined direction to a specific location on the inner wall of the container. The geometry of the container and its inner wall can support the mixing process in conjunction with the trajectory curve, so that the trajectory curve can be adjusted depending on the shape and size of the container cross-section.

Optionally, the device is set up to change the trajectory curve of the reciprocating movement and/or the acceleration and/or speed of the reciprocating movement during the process, e.g. in a first phase to set the reciprocating movement along a first trajectory curve and with a first acceleration and speed and to set the reciprocating movement in a subsequent second phase along a changed trajectory curve and/or changed acceleration and/or speed.

Further optionally the reciprocating movement is a linear reciprocating movement in a first phase and a reciprocating movement along merging trajectory curves in a second phase. Therein, the trajectory curve can, for example, be determined by a transmission that drives the movement of the container.

By adjusting the trajectory curve and acceleration of the reciprocating movement of the container, the device permits a predetermined or dynamically variable and directed acceleration of the contents as process material relative to the container. In general, the container holder and a container attached thereto can be driven in a controlled manner in a first phase for a linear reciprocating movement, for example by only one of the levers being driven for a reciprocating movement, while the other lever is not driven and is pivoted, for example, between the eccentric drive and the container holder.

The container holder is adapted for mounting of a container. In an embodiment in which the container is firmly connected to the container holder, the container holder has a container or the container holder forms the container, e.g. as one part. The container can generally have a closable opening, e.g. a lid that can be opened and closed at a terminal cross-sectional opening, or a lid that can be opened and closed at each of the opposing terminal cross-sectional openings of the container. Further alternatively, the container may have two spaced openings, one of which forms a feed opening and the other a removal opening, e.g. for the continuous feed of ingredients and removal of a mixture produced therefrom.

In an embodiment, in which the container may be driven in a controlled manner in a first phase to a linear reciprocating motion, the device is adapted to move solids and/or liquids and the mixture thereof in perpendicular against the container wall with a controllable acceleration which is significantly greater than the acceleration due to gravity and therefore substantially independent of the acceleration due to gravity. In general, in particular when moving the container holder along a trajectory curve, the acceleration can be at least 15 m/s², preferably 25 m/s², preferably at least 50 m/s² or at least 100 m/s² or at least 200 m/s² or at least 350 m/s², e.g. up to 500 m/s² in each case.

In general, the device can be set up to accelerate the container holder and a container attached to it with an acceleration of at least 20 m/s² or at least 100 m/s², e.g. at least 200 m/s², preferably up to 1000 m/s² or up to 300 m/s² along the curve segments, e.g. at an apex of the curve segments.

The container holder and the container attached thereto are preferably driven to a reciprocating movement with an acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. up to 300 m/s² or 450 m/s², up to 260 m/s² or up to 250 m/s² along each of two axes. Generally preferably, the container is driven in combination with the acceleration to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. The path of the movement along at least one axis, preferably along each axis, is e.g. 0.1 cm to 24 cm.

The container holder and the container attached to it can, for example, be driven to a reciprocating movement which extends along each axis over a path of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container holder can be linear in a first phase, generally the trajectory curve is non-linear and can be sinusoidal, loop-shaped or arc-shaped, for example, preferably running along a so-called Lissajous figure or hypocycloid, which preferably lies in the plane or is two-dimensional, or which is three-dimensional in that the container holder is moved along an arc, the radius of which is formed by the first pivot arm. Preferably, the reciprocating movement is linear in a first phase and in a second phase along at least two non-linear curve segments that merge into one another, each containing at least one apex, to form a trajectory curve. This is because a non-linear trajectory curve, e.g. a movement along a trajectory curve whose curve segments each have at least one apex, generally promotes an impact of solids and/or liquids and the mixture of these, e.g. perpendicular to the container wall, as well as a movement along the container wall.

Preferably, the reciprocating movement comprises the reciprocating movement along a trajectory curve which comprises at least two, preferably at least three, more preferably at least four different curve segments, each of which has at least one apex and preferably merge into one another in a time sequence, preferably programme-controlled. Each of the movement axes along which the movements are superimposed to form a trajectory curve can be linear or arcuate, so that the non-linear movement of the container holder along a sequence of curve segments is generated from the superimposition of the movements along two movement axes. The apices and intermediate sections of a curve segment are determined by the frequency difference and/or the phase position of the superimposed reciprocating movements along at least two axes. In general, the device can be set up to change the frequency difference and/or the phase position during the reciprocating movement.

The invention is now described in more detail with reference to the figures, which schematically show in

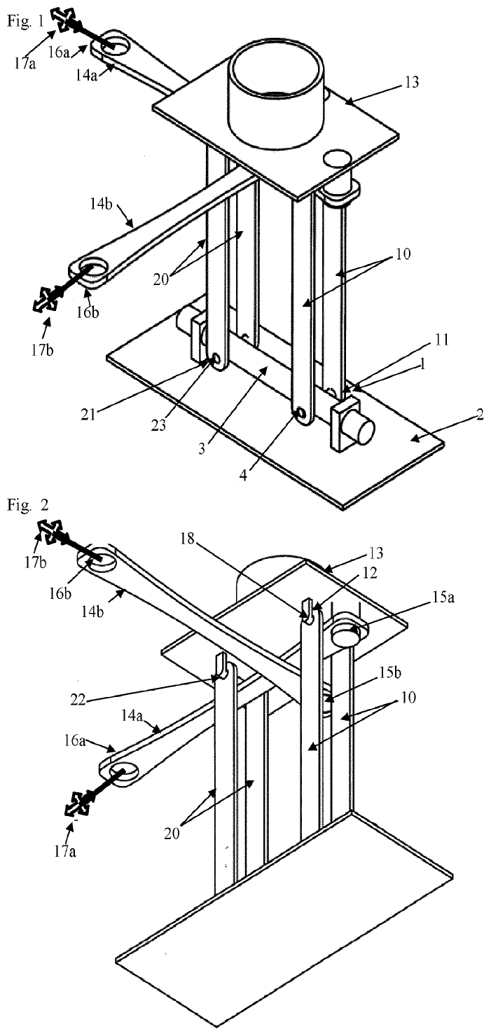

FIG. 1 a perspective view of the device and

FIG. 2 is a rotated perspective view of the device of FIG. 1,

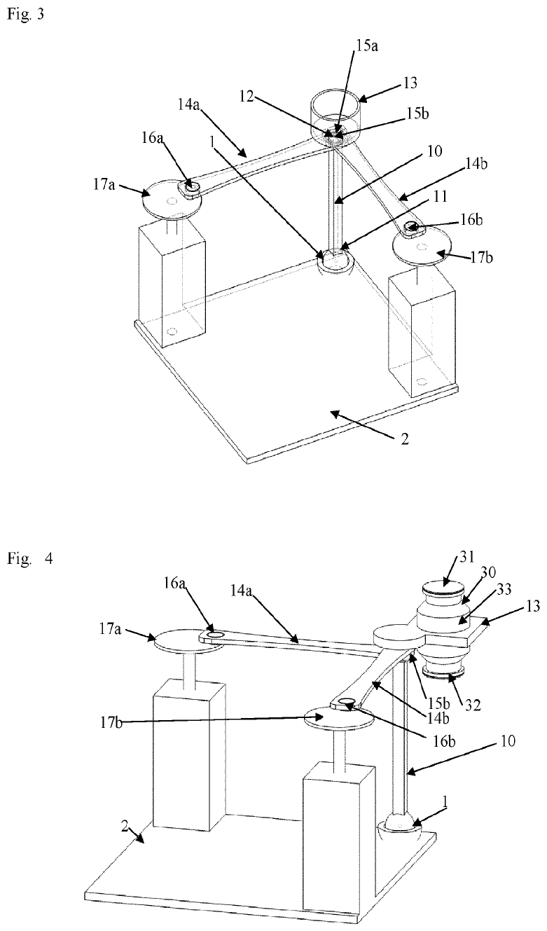

FIG. 3 a further embodiment of the device,

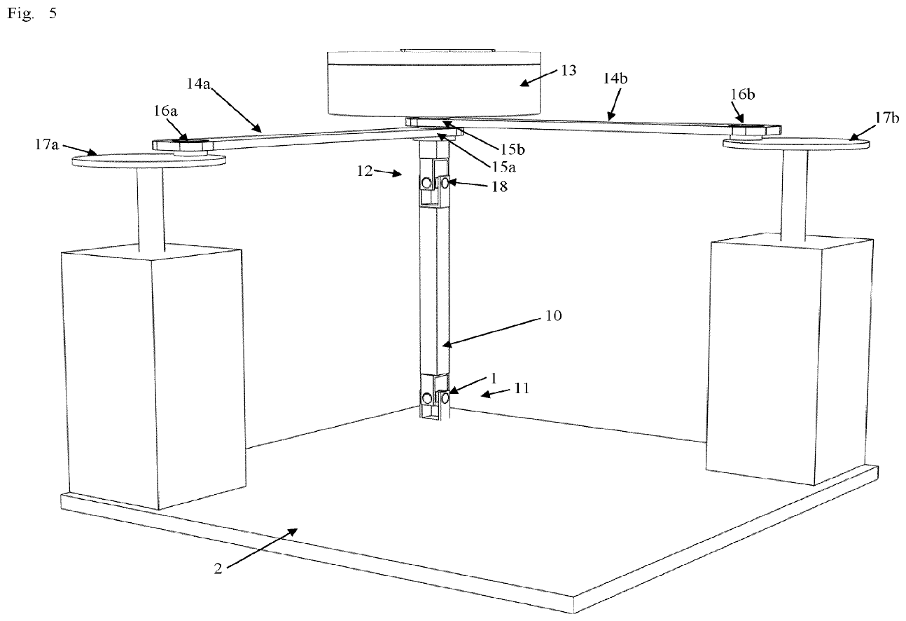

FIG. 4 a further embodiment of the device, and

FIG. 5 a further embodiment of the device.

The individual elements shown in the figures can be included in any of the embodiments. FIGS. 1 and 2 show an embodiment of the device according to the invention, in which the first pivot bearing 1 is attached to a frame part 2. The first pivot bearing 1 has two spaced-apart, perpendicular axes, one of which is formed by a carrier 3 mounted rotatably about its longitudinal axis and the other by a pivot bearing 4 attached to the carrier 3, in which pivot bearing the first end 11 of the first pivot arm 10 is articulated. In the embodiment shown here, the first pivot arm 10 is formed by two parallel partial arms, which are articulated on both sides of the carrier 3. The second end 12 of the first support 10 is articulated to a container holder 13 so as to be pivotable about an axis which is arranged parallel to the axis of the pivot bearing 4. In the embodiment shown, the device has a second pivot arm 20, which is arranged parallel to the first pivot arm 20 and is articulated at its first end 21 and opposite its second end 22 to a third pivot bearing 23. The third pivot bearing 23 is formed in the same way as the first pivot bearing 1 and, in the embodiment shown, is coupled to the first pivot bearing 1 in that the second end 22 is pivotably articulated about an axis to the same rotatably mounted carrier 3 as the first pivot arm 10. The first pivot bearing 1 and the third pivot bearing 23 have parallel and spaced-apart axes.

The second end 12 of the first pivot arm 10 and the second end 22 of the second pivot arm 20 are each articulated to the container holder 13 by a second pivot bearing 18.

A first lever 14a is pivotably articulated at its first end 15 to the container holder 13 and is driven at its opposite second end 16a by a first eccentric drive 17a for reciprocating movement. A second lever 14b is arranged approximately perpendicular to the first lever 14a in the illustrated centre position of the pivoting movement, both levers 14a, 14b being arranged approximately perpendicular to the longitudinal axis of the first pivoting arm 10. The second lever 14b is driven at its opposite second end 16b by a second eccentric drive 17b for reciprocating movement.

FIG. 3 shows an embodiment which has exactly one first pivot arm 10, the first end 11 of which is freely pivotably run in a first pivot bearing 1, which is a ball joint. The second end 12 of the first pivot arm 10 is pivotably articulated to the first end 15a of a first lever 14a and pivotably articulated to the first end 15b of a second lever 14b, which is arranged at an angle of 60 to 120° to the first lever 14a. As preferred, the first and second levers 14a, 14b are arranged in a plane which is approximately perpendicular to the extension of the first pivot arm 10, optionally parallel to the plane in which the frame part 2 lies. Alternatively, one or both of the first and second levers 14a, 14b can be arranged at an angle of, for example, 85 to 45° or up to 60° to the longitudinal axis of the first pivot arm 10. The first lever 14a is driven to move reciprocating along its longitudinal axis by a first eccentric drive 17a articulated at its second end 16a. The second lever 14b is driven to move reciprocating along its longitudinal axis by a second eccentric drive 17b articulated at its second end 16b. Thereby, the first lever 14a and the second lever 14b are set up for pivoting the first pivot arm 10 in the first pivot bearing 1 and for pivoting the second end 12 of the first pivot arm 10 along the longitudinal axes of the first lever 14a and the second lever 14b, wherein the pivoting in the first pivot bearing 1 causes the second end 12 of the first pivot arm 10 to move reciprocating at larger and smaller spacings from the plane of the frame part 2.

FIG. 4 shows an embodiment in which a container 30 is detachably or fixedly attached to the container holder 13. The opposing terminal cross-sectional openings of the container 30, which can optionally extend rotationally symmetrically between its terminal cross-sectional openings, form a feed opening 31 for ingredients to be treated and a removal opening 32 for treated ingredients, in particular a mixture of the ingredients. The feed opening 31 and the removal opening 32 may have a lid for reversible closure or may be open for continuous supply of ingredients and/or continuous removal of the mixture of ingredients. The container 30 may have a cross-section that increases from the feed opening 31 to a middle section 33 and/or decreases from a middle section 33 to the removal opening 32.

FIG. 5 shows an embodiment with a first pivot arm 10, which is pivotably attached to a frame part 2 at its first end 11 by means of a first pivot bearing 1, which is formed by a universal joint. The container holder 13 is attached to the second end 12 of the first pivot arm 10 by means of a second pivot bearing 18, so that the container holder 13 is pivotably articulated to the first pivot arm 10. The first lever 14a is pivotably hinged by its first end 15a to the first pivot arm 10 in a region which is fixedly connected to the container holder 13 and which lies correspondingly along the first pivot arm on a section thereof opposite the first end 11 or opposite the first pivot bearing 1 which section is articulated to the second pivot bearing 18. The second lever 14b is also pivotably articulated by its first end 15b to the first pivot arm 10 in the region which is fixedly connected to the container holder 13. In this general embodiment, the container holder 13 is connected to the first pivot arm 10 in that the first ends 15a, 15b of the first and second levers 14a, 14b are articulated to a region which is part of the container holder 13 and/or is fixedly connected to the container holder 13, in particular are articulated to a section 12a of the first pivot arm 10 which is articulated to the second pivot bearing 18 opposite the first pivot bearing 1, the container holder being fixedly connected to this section 12a.

Reference sign:

| | |
|---|---|
| 1 | first pivot bearing |
| 2f | Frame part |
| 3 | carrier |
| 4 | pivot bearing |
| 10 | first pivot arm |
| 11 | first end |
| 12 | second end |
| 12a | section of the first pivot arm |
| 13 | container holder |
| 14a | first lever |
| 15a | first end |
| 16a | second end |
| 14b | second lever |
| 15b | first end |
| 16b | second end |
| 17a | first eccentric drive |
| 17b | second eccentric drive |
| 18 | second pivot bearing |
| 20 | second pivot arm |
| 21 | first end |
| 22 | second end |
| 23 | third pivot bearing |
| 30 | container |
| 31 | feed opening |
| 32 | removal opening |
| 33 | middle section |

1. A device for the reciprocating movement of a container holder along a trajectory curve, comprising:
a first pivot arm articulated at its first end to a first stationary first pivot bearing, wherein the first pivot bearing is configured to pivot along two axes which are arranged perpendicular to the longitudinal axis of the first pivot arm;
a container holder attached to a second end of the first pivot arm opposite the first end;
a first lever driven for reciprocating movement, is the first lever being articulated to the first pivot arm at a spacing from the first end of the first pivot arm; and
a second lever driven for reciprocating movement and articulated to the first pivot arm at a spacing from the first end of the first pivot arm, wherein the first lever and the second lever are arranged to create movement of the first pivot arm about the two axes of the first pivot bearing.

2. The device according to claim 1, comprising a first eccentric drive configured to create reciprocating movement of the first lever and a second eccentric drive configured to drive the second lever.

3. The device according to claim 2, wherein the first eccentric drive and the second eccentric drive each comprise a controlled rotary motor which is mounted in a fixed position.

4. The device according to claim 3, wherein the controlled rotary motor of the first eccentric drive and of the second eccentric drive comprise a common rotary motor with a transmission.

5. The device according to claim 1, comprising a second pivot arm arranged parallel to the first pivot arm and articulated at its first end in a third pivot bearing and by its opposite second end is connected to the container holder.

6. The device according to claim 1, wherein the second end of the first pivot arm is articulated to the container holder by a second pivot bearing.

7. The device according to claim 1, wherein the first pivot bearing comprises two axes which are arranged perpendicular to one another and perpendicular to the longitudinal axis of the first pivot arm.

8. The device according to claim 7, wherein the two axes of the first pivot bearing are spaced apart or intersect.

9. The device according to claim 2, wherein the first and second eccentric drives are mounted on a common frame.

10. The device according claim 5, wherein the first pivot bearing and the third pivot bearing comprise pivot axes parallel to one another.

11. The device according to claim 2, comprising control to drive the first eccentric drive and the second eccentric drive with one or both of different frequencies and phase offset.

12. The device according to claim 1, wherein the container holder is firmly connected to a section of the first pivot arm, which opposite the first pivot bearing is articulated on a second pivot bearing arranged in the first pivot arm, wherein the first end of the first lever and the first end of the second lever are articulated to a region which is part of the container holder and/or which is connected to the container holder.

13. The device according to claim 1, wherein the first pivot bearing and a second pivot bearing are arranged independently of one another by a ball joint or a universal joint or a cardan bearing.

14. The device according to claim 1, comprising a container fixed to the container holder, wherein opposite cross-sectional openings of the container are open for continuous supply and continuous removal.

15. The device according to claim 1, comprising a container fixed to the container holder, wherein a cross-section of the container increases from a feed opening to a middle section and decreases from the middle section to a removal opening opposite the feed opening.

16. A method for treating ingredients in a container, comprising driving and positively guiding the container along a trajectory curve by a device according to claim 1, wherein the first lever and the second lever are driven for reciprocating movement at one or both of different frequencies and phase offset.
